(19) United States
(12) Patent Application Publication
(10) Pub. No.: US 2025/0233760 A1
(43) Pub. Date: Jul. 17, 2025

(54) DEVICES, SYSTEMS AND METHODS FOR SECURING COMMUNICATION INTEGRITY

(71) Applicant: Emory University, Atlanta, GA (US)

(72) Inventor: Ymir VIGFUSSON, Atlanta, GA (US)

(73) Assignee: Emory University, Atlanta, GA (US)

(21) Appl. No.: 18/853,930

(22) PCT Filed: Apr. 12, 2023
(86) PCT No.: PCT/US2023/018393

§ 371 Date: Oct. 3, 2024

Related U.S. Application Data
(60) Provisional application No. 63/330,875, filed on Apr. 14, 2022.

(51) Int. Cl. H04L 9/32

(52) U.S. Cl. CPC H04L 9/3268

(57) ABSTRACT

Devices, systems, arid methods are provided for securing communication integrity. An. input Signal associated with a user using a remote connection to access a client server can be received. The input signal may identify an. input received via an interface. An. integrity module can be executed to generate an integrity certificate using the input signal, a secret key, and a sequential identifier corresponding to the input The integrity certificate can be generated for use during a verification process associated with the input signal. The integrity certificate and the input signal can be transmitted to the client server using one or more channels. The client server can forward the integrity certificate and the input signal to a verification server configured to validate the integrity certificate.

### CROSS-REFERENCES TO RELATED APPLICATIONS

The application claims the benefit of and the priority to U.S. Provisional Application No. 63/330,875, filed Apr. 14, 2022, which is hereby incorporated by reference in its entirety for all purposes.

### TECHNICAL FIELD

The present disclosure relates generally to information security. More specifically, but not by way of limitation, this disclosure relates to devices, systems, and methods for securing communication integrity.

### BACKGROUND

The incidents of cybersecurity attacks to gain access and control over an organization's resources (such as credit card databases, code repositories, secret intellectual property and blueprints) have been increasing every year. The most common mode of attacks has involved compromising the computer of an employee, in any of myriad ways (remote attacks, phishing campaigns, infected attachments, malware via browser, etc.). By gaining access to employee's computer, the attacker can now move laterally between computers inside the organization through the remote access to the machine by assuming the employee's credentials.

It can be difficult to detect whether or not a computer has been hacked or compromised due to the level of sophistication of modern attack tools to evade security tools, such as IPS/IDS systems and anti-virus. This has created a push towards “zero trust” security policies among more mature organizations, whereby end-user devices (and possibly other servers) are assumed to be compromised.

In line with this movement, some form of authentication technology, typically multi-factor authentication such as one-time password (OTP) tokens or push-based mobile apps, have been implemented to enhance the cybersecurity. These technologies endow the session with the remote server with confidentiality and integrity when the end-user authenticates at the log-in. However, these technologies cannot maintain such security properties if the end-user or the remote server have been compromised by an attacker. In particular, these technologies have generally neither able to detect nor prevent an attacker who has compromised the end-user computer from “stealing” an established session to the remote server (e.g., after verification) or initiating a clandestine session, such as a session in the background. In the absence of session integrity during compromise, an attacker may be able to impersonate the end-user and issue rogue commands on the remote server.

### SUMMARY

Thus, there is a need for devices and systems that can provide a secure access particularly session integrity, during an entire communication session with a remote server even in the presence of a cyberattack on the end-user's system, as well as detecting such cyberattack.

In some embodiments, a computer-implemented method is provided that involves receiving an input signal associated with a user using a remote connection to access a client server, the input signal identifying an input (e.g., keystrokes, mouse clicks or movements, joystick or game controller interaction, or touchscreen interaction) received via an interface (e.g., a keyboard, mouse, joystick, game controller, etc.). The method further involves executing an integrity module to generate an integrity certificate using the input signal and a secret key corresponding to the input, the integrity certificate being generated for use during a verification process associated with the input signal. In some examples, executing the integrity module to generate the integrity certificate may involve using a sequential identifier (e.g., a counter, a timestamp, a suitable function derived from the counter, etc.) in addition to the input signal and the secret key. The integrity module can generate a tuple encoding the integrity certificate such that the tuple includes the sequential identifier indicating an order of the input signal and an integrity key. The integrity key can be created based on the input signal, secret key, and sequential identifier using a cryptographic protocol (e.g., cryptographic hash function, digital signature scheme, etc.). The method additionally involves transmitting the integrity certificate and the input signal to the client server using one or more channels. The client server can be configured to forward the integrity certificate and the input signal to a verification server configured to validate the integrity certificate.

In some embodiments, a system is provided that includes one or more data processors and a non-transitory computer-readable storage medium containing instructions which, when executed on the one or more data processors, cause the one or more data processors to perform part or all of one or more methods disclosed herein. The instructions can include actions associated with the one or more methods disclosed herein.

In some embodiments, a computer-program product is provided that is tangibly embodied in a non-transitory machine-readable storage medium and that includes instructions configured to cause one or more data processors to perform part or all of one or more methods disclosed herein. The instructions can include actions associated with the one or more methods disclosed herein.

Some embodiments of the present disclosure Include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

The disclosure can be better understood with the reference to the following drawings and description. The components in the figures are not necessarily to scale, the emphasis being placed upon illustrating the principles of the disclosure. The present disclosure is described in conjunction with the pended figures:

FIG. 1 illustrates an example of system environment for validating an integrity of an input of an input stream using a generated key according to embodiments.

FIG. 2 illustrates an example of a system environment for validating a set of input signals of an input from a web server using a set of generated integrity keys according to embodiments.

FIG. 3 is an example of a hardware implementation of the integrity module shown in FIG. 1 according to embodiments.

FIG. 4 is an example of a software implementation of the integrity module shown in FIG. 1 according to embodiments.

FIG. 5 shows a flowchart illustrating an example of a method of generating an integrity certificate for inputs(s) of a stream using a hardware implementation of the integrity module and verifying the input using the generated certificate according to embodiments.

FIG. 6 shows a flowchart illustrating an example of a method of generating an integrity certificate for input(s) of a stream using a software implementation of the integrity module and verifying the input using the generated certificate according to embodiments.

FIG. 7 shows a flowchart illustrating an example of a method of generating an integrity certificate for input(s) of a stream and verifying the input(s) using the generated certificate within a browser according to embodiments.

FIG. 8 is a data flow diagram depicting an example of a data flow for pairing an integrity key of an agent to a user identifier of a terminator according to embodiments.

FIG. 9 is a simplified block diagram of an example of a computing system for implementing certain embodiments disclosed herein.

### DESCRIPTION OF THE EMBODIMENTS

In the following description, numerous specific details are set forth such as examples of specific components, devices, methods, etc., in order to provide a thorough understanding of embodiments of the disclosure. It will be apparent, however, to one skilled in the art that these specific details need not be employed to practice embodiments of the disclosure. In other instances, well-known materials or methods have not been described in detail in order to avoid unnecessarily obscuring embodiments of the disclosure. While the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the disclosure.

This disclosure generally relates to techniques that can authenticate input associated with a user throughout an entire session of communications to control access to a client server. Examples of the input can include keystrokes, mouse clicks or movements, joystick or game controller interaction, or touchscreen interaction. The disclosed techniques can be configured to authenticate each input signal and/or a subset of input signals in a stream of user input detected by a human interface device (HID) (e.g., each keystroke) coupled to a user computing device by verifying a secret key associated with that user and/or device that is transmitted with each input signal. In some examples, the stream of user Input that is authenticated can include one or more of keystrokes, mouse clicks, mouse movements, or other suitable user input as the input signals. For example, a subset of the stream including keystrokes may be interleaved with another subset of the stream including mouse movements.

The secret key according to the disclosure remains internal (e.g., by preventing exposure of the secret key to potential malicious actors) so that it is not communicated or externalized directly. Examples of the secret key can include symmetric keys or asymmetric keys for encryption. Creating the symmetric keys can involve using symmetric cryptography, and creating the asymmetric keys can involve asymmetric public-key cryptography. In some examples, the secret key may be generated in an external system (e.g., an external key generation program) prior to uploading the secret key to be used according to the disclosure. By using the secret key internally, the disclosed techniques can provide security and integrity (e.g., relatively high confidence that messages are unaltered) of the entire session of communications. By automatically verifying the input (i.e., matching the user input with integrity attestations), the disclosed techniques can also enable detection of an attack (e.g., cyberattack) or another action by a malicious actor such that a suitable security measure can be implemented to address the attack. Thus, using the processes and devices as described herein, the security and integrity of the data (e.g., control messages, input signals, etc.) transmitted during an entire session of communications can be substantially guaranteed, thereby decreasing the risk of unauthorized access to protected computing resources (e.g., the computer, network, or the data transmitted). The disclosed techniques can therefore address the deficiencies of current authentication techniques, for example by verifying each input signal during a communication session rather than using a one-time user authentication to initiate the communication session.

Various embodiments implementing these techniques are described herein, including systems, methods, devices, modules, models, algorithms, networks, structures, processes, computer-program products, and the like. Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

The present description provides preferred exemplary embodiments only, and is not intended to limit the scope, applicability or configuration of the disclosure. Rather, the present description of the preferred exemplary embodiments will provide those skilled in the art with an enabling description for implementing various embodiments. It is understood that various changes may be made in the function and arrangement of elements without departing from the spirit and scope as set forth in the appended claims.

Specific details are given in the present description to provide a thorough understanding of the embodiments. However, it will be understood that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

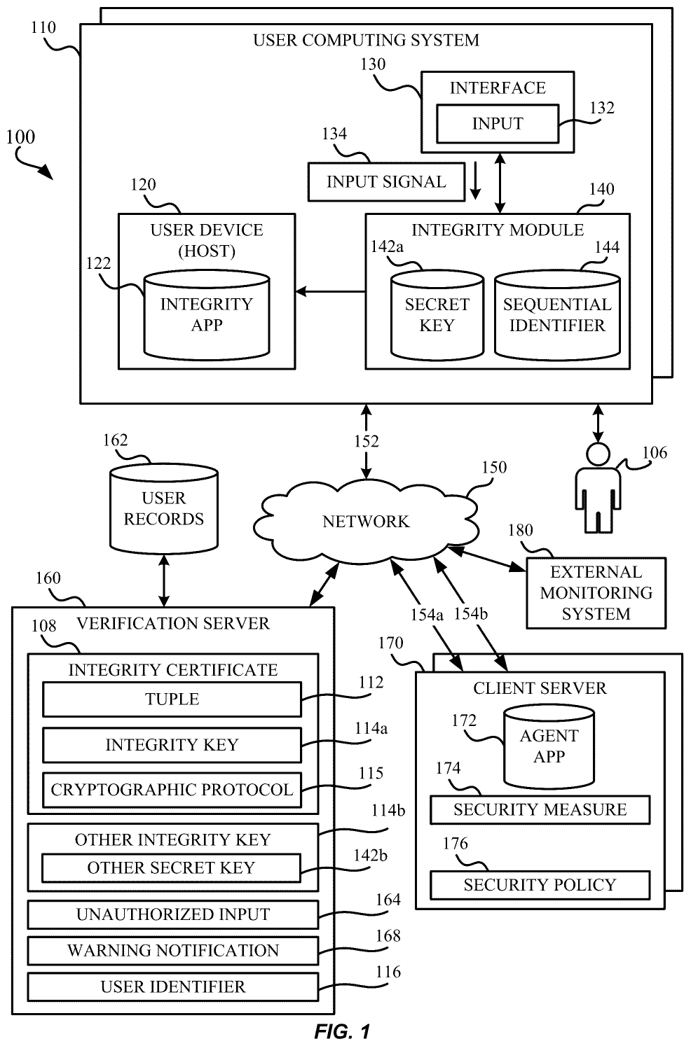

FIG. 1 depicts an example of a system environment 100 in which an input 132 (e.g., keystroke) to a user computing system 110, detected using an interface 130, can be verified during a communication session with or via one or more client servers 170. In some embodiments, the system environment 100 may include one or more of a user computing system(s) 110, a network 150, a verification server 160, and/or one or more client server(s) 170. The various systems and components described herein may be in direct logical communication with each other in a bus, network, and/or through any other suitable means, or may be individually connected as described further herein. As described in greater detail below, appropriate programming (i.e., computer program, software, hardware, firmware, etc.) can be installed on or provided with each of each user computing system 110, the verification server 160, each remote client server 170 (e.g., agent app 172), and can operate in a coordinated fashion to perform the methods of the present disclosure.

In various embodiments, the user computing system 110 may include a user device 120 associated with a user 106. The user device 120 may include any type computing device or computer including but not limited to, for example, a laptop computer, personal computer, network device, cellular phone, handheld communication device, or any other device. The user computing system 110 may include at least one interface 130 connected to or built into the user device 120. The interface 130 may be any human interface device (HID) configured to detect user input 132 and transmit at least one input signal 134 in response to detecting the input 132.

In this example, as shown in FIG. 1, the interface 130 may be a keyboard capable of transmitting a keycode as the input signal 134 corresponding to ystroke inputted using the keyboard. The keyboard can transmit each keycode in response to the user 106 selecting one or more keyboard keys of the keyboard to input each keystroke. For example, each keycode may be a hexadecimal representation of the physical character typed on the keyboard. The keyboard may include but is not limited to a physical keyboard, such as a peripheral device connected to the user device 120 using wired (e.g., cable) or wireless means, such as Bluetooth® connectivity, a touch screen, among others, or a combination thereof. It will be understood that that the interface 130 is not limited to a keyboard and may include alternative and/or additional devices, including but not limited to mouse, joystick, game controller, among others, or any combination thereof.

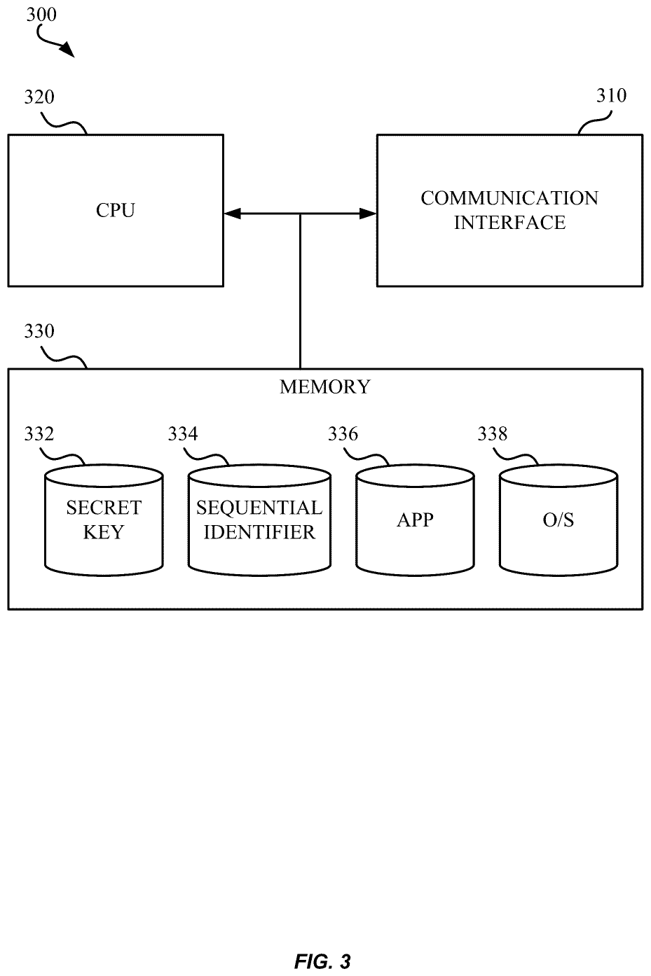

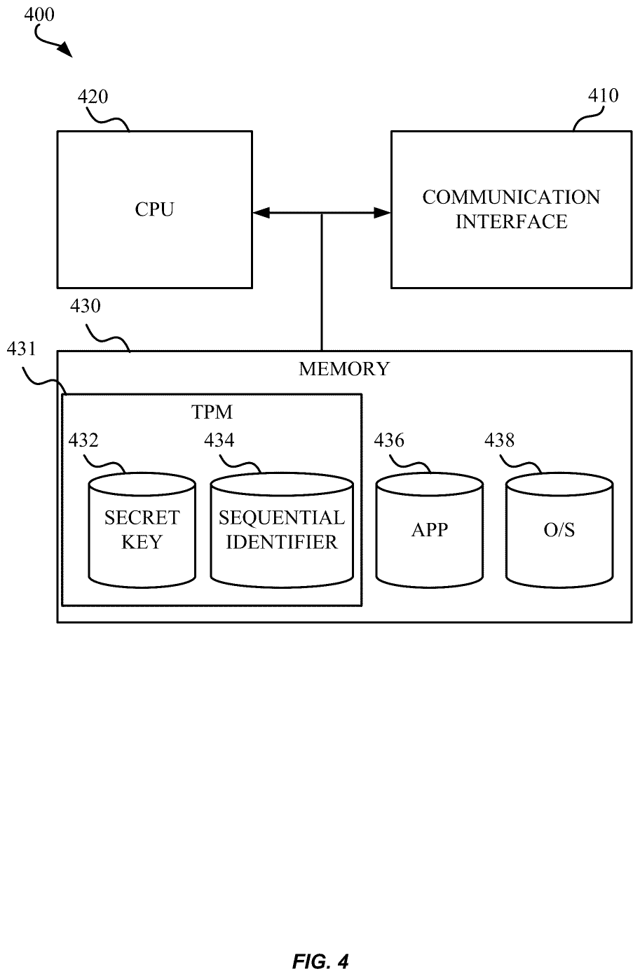

In various embodiments, the user computing system 110 may include an integrity module 140 disposed between the interface 130 and an operating system or target application of the user device 120. The integrity module 140 may be a hardware or software element configured to generate integrity information (e.g., an integrity certificate 108) for at least a subset of the input 132 received from the interface 130 and a secret key 142 registered to the user 106 of the user device 120 or integrity module 140. Once the integrity module 140 generates the integrity certificate 108, the integrity module 140 can transmit the integrity certificate 108 for verification by the verification server 160 during the communication session. The integrity module 140 may be a hardware device configured to be connected to the user device 120 and/or to the interface 130, software installed on or operated by the user device 120 and/or interface 130, among others, or a combination thereof. FIG. 3 shows an example of a hardware implementation of the integrity module 140, and FIG. 4 shows an example of a software implementation of the integrity module 140.

Each integrity module 140 may store the secret key 142 that can be used to authenticate an identity of the user 106 to verify and allow the input 132 received by the interface 130 with respect to accessing the client server 170. In some examples, the integrity module 140 may enable controlled access of protect computing resources. Examples of the protected computing resources can include interactive computing environments, software applications, databases, files, etc. The one or more protected computing resources can be associated with the user computing system 110, the client server 170, or a combination thereof. The secret key 142 may be a sequence of bits associated with the user 106 of the user device 120 and/or the integrity module 140 and may be shared with the verification server 160. The secret key 142 can be a symmetric key or part of an asymmetric key pair that includes a public key and a private key usable to decrypt the public key. Examples of symmetric key techniques can include stream ciphers (e.g., ChaCha) or block ciphers (e.g., Advanced Encryption Standard (AES)). Examples of asymmetric key techniques can include elliptic-curve cryptography, Rivest-Shamir-Adleman (RSA) encryption algorithm, etc. If the secret key 142 is the public key of the asymmetric key pair, the secret key 142 can be used to encrypt data to generate ciphertext, while the private key can be used to decrypt the ciphertext. In some examples, instead of being associated with the user 106, the secret key 142 may be associated with the user device 120, a virtual machine, or another suitable device.

Bach integrity module 140 may also include one or more sequential identifiers 144 (e.g., counters, timestamps, random numbers, any suitable function derived from an underlying counter, etc.). In some examples, the sequential identifier(s) 144 may be an application transaction counter (ATC). If the sequential identifier 144 is a random number, the integrity module 140 may use a random seed to initialize a random number generator that generates the sequential identifier(s) 144. In some examples, the integrity module 140 may generate an integrity key 114a (“IK”, also referred to as “IK₁”) for each received input 132 using at least a subset of the input 132 received from the interface 130, the stored secret key 142, and the sequential identifier 144. In this example, the ATC may be a mmnber that is incremented with every generation of the integrity key 114a so that that each number in the integrity certificate 108 is unique. In some other examples, there may be multiple ATC counters, for example if the user computing system 110 includes more than one user device 120 that each include a respective sequential identifier. In some examples, the integrity module 140 may generate the integrity certificate 108 using additional or alternative information to the sequential identifier 144. For example, the integrity module 140 may generate a tuple 112 as the integrity certificate 108 using other identifiers, time stamps, random or pseudo-random numbers, pre-defined sequences, biometric information, measurement data, other information, among others, or any combination thereof.

In some examples, the integrity key 114a may be generated based on an input signal 134 (e.g., a keycode corresponding to the characters inputted using the interface 130, relative coordinates of a mouse during a click, tap coordinates of a touchscreen, etc.), the stored secret key 142, the sequential value determined by the sequential identifier 144, using a cryptographic protocol 115. In some examples, the cryptographic protocol 115 may be a hash-based message authentication code (HMAC). Additionally or alternatively, the cryptographic protocol 115 may be an alternate hash function, a digital signature digest, or an encoding or encryption of the input 132 using a separate cryptographic key. In this example, the integrity certificate 108 may include the integrity key 114a, input signal 134, and sequential identifier 144 or sequential value. In some examples, the integrity certificate 108 may be in a form of a 3-tuple <input signal 134, sequential identifier, IK>. Alternatively, the integrity certificate 108 may be a 2-tuple (e.g., <sequential identifier, IK>).

In some examples, the integrity module 140 may transmit the integrity certificate 108 and the input signal 134 to the user device 120, for example, by using standard or custom USB or Bluetooth® protocols. The integrity certificate 108 may be serialized as bits, encoded as characters, or use other known methods of information transfer via the protocols. Specifically, the integrity certificate 108 can be encrypted prior to being transmitted to the verification server 160, enabling relatively higher security by limiting security risk related to interception of the integrity certificate 108.

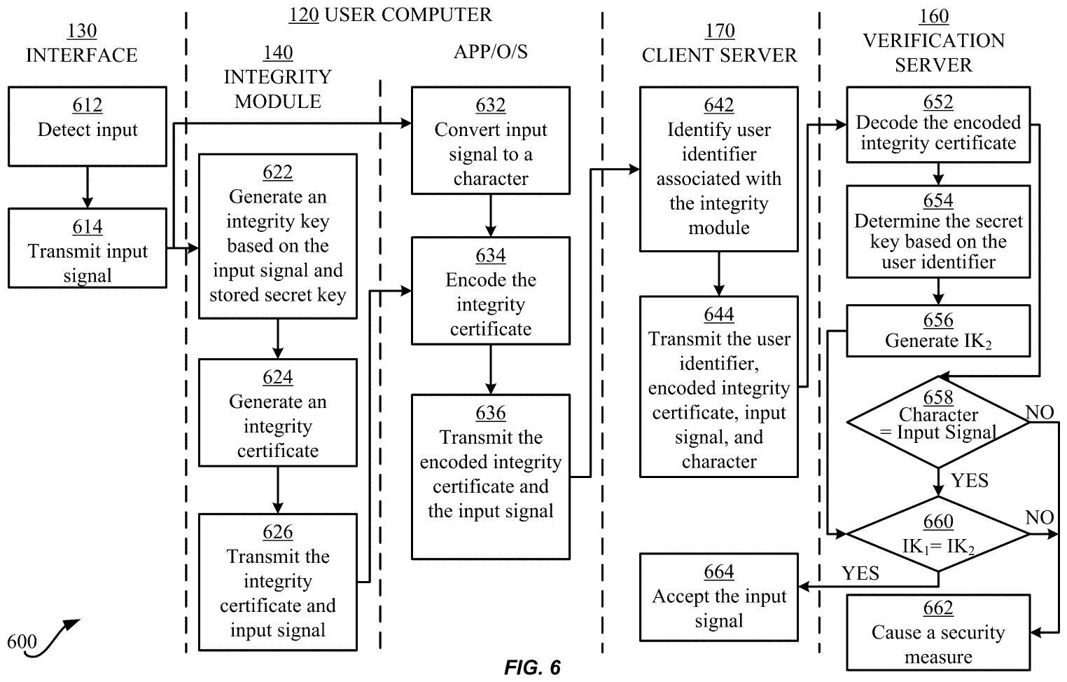

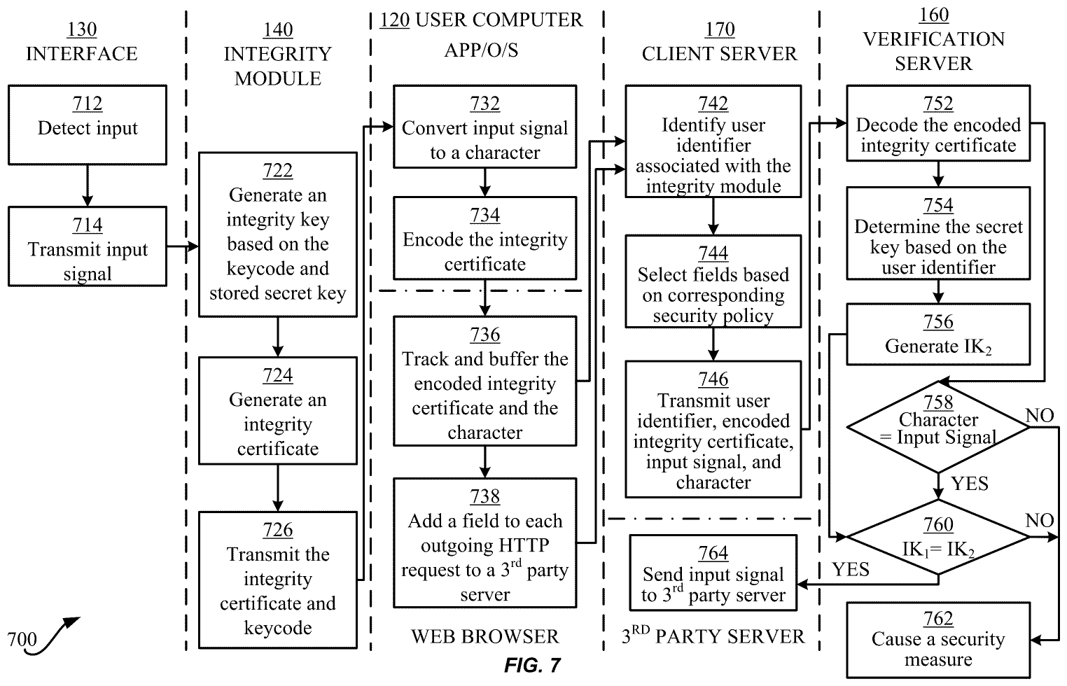

In some examples, as shown and described with respect to FIGS. 6 and 7, after the user device 120, uses an integrity application 122 (e.g., driver, kernel module, privileged program in user space, etc.) to encode the integrity certificate 108, the user device 120 may transmit a message including the encoded characters corresponding to a serialization of the integrity certificate 108 and the character(s) corresponding to the input signal 134 to the client server 170 to determine a user identifier 116 associated with the communication session, user device 120 and/or the integrity module 140. For example, the user identifier 116 may be determined using existing authentication processes, pre-populated by a system administrator, entered by the user 106, inferred from other input or data, or other suitable methods.

In some examples, when implemented in browser support, for example, as shown and described with respect to FIG. 7, after the user device 120, for example, using an integrity application 122 (e.g., driver) encodes the integrity certificate 108, the user device 120 may transmit a message using an HTTP request to the client server 170 with the user identifier 116. Alternatively, the message transmitted by user device 120 may be transmitted through Websockets, raw TCP connections, or any other communication protocol.

After the user identifier 116 is determined, the client server 170 may send a message to the verification server 160 to verify the input 132 detected by the integrity module 140. The message can include the encoded integrity certificate 108, the user identifier 116, and a character corresponding to the input signal 134. In examples in which the interface 130 includes multiple possible input layouts (e.g., keyboard layouts), the message may include a set of possible characters such that the verification server 160 can compare each character of the set of possible characters to determine a match. For example, if the multiple input layouts are keyboard layouts, the set of possible characters can correspond to a physical key on the interface 130 that is pressed by the user 106 to generate the input 132. Specifically, the user 106 may use language software associated with an operating system of the user device 120 to change a keyboard layout of the interface 130. As an illustrative example, changing the keyboard layout from an English keyboard layout to a Spanish keyboard layout may cause the interface 130 to detect ‘ñ’ as the input 132 instead of ‘;’ when the user 106 presses the key for a semicolon. Accordingly, the message transmitted by the client server 170 to the verification server 160 may include both ‘ñ’ and ‘;’ as possible characters used by the verification server 160 to determine a match with the input signal 134.

In some examples, the user device 120 may use separate communication channels 154a-b to transmit information to the client server 170 and the verification server 160. Specifically, the user device 120 can transmit the input signal 134 to the client server 170 using a first channel 154a communicatively coupling the user computing system 110 and the client server 170. The user device 120 can use a second channel 154b to transmit the integrity certificate 108 to the verification server 160, the client server 170, or another suitable computing system communicatively coupled to the user computing system 110. In additional or alternative examples, the two communication channels between user device 120 and client server 170 may be combined. In such examples, the user device 120 can send an integrity certificate 108 through the combined channel according to existing protocols, for example as an out-of-band message, by transmitting and later deleting the same content, or other suitable mechanisms.

In some examples, the verification server 160 may decode, deserialize, or unpack the integrity certificate 108 to determine the input signal 134, the sequential identifier 144, and the integrity key (IK₁) 114a. The verification server 160 may retrieve another secret key 142b associated with the user identifier 116 from a user record database 162 that is communicatively coupled to the verification server 160. In some examples, the user record database 162 may also include security profiles for each user 106 that are used to determine a suitable security measure 174 in response to unauthorized input 164. By way of example, each integrity module 140 and/or user device 120 may be registered to a user identifier 116 and a secret key 142. If the integrity module 140 uses asymmetric cryptography, the secret key 142 can correspond to a public key of an asymmetric key pair generated for the integrity module 140. A private key of the asymmetric key pair corresponding to the secret key 142 can be stored on the user device 120. After the verification server 160 determines the other secret key 142b associated with the user 106, the verification server 160 may generate another integrity key (“IK₂”) 114b using the other secret key 142b, the sequential identifier 144, and the input signal 134 included in the message, in some examples following the logic described above.

The verification server 160 may be configured to (i) verify the input signal 134 included in the message matches the character included in the message; and (ii) verify that the generated (or second) integrity key 114b associated with the input 132 matches the (first) integrity key 114a received in the message. If this verification is successful (i.e., both information matches), the verification server 160 can communicate to the client server 170 to accept the inputted character and the client server 170 can accept the inputted character as input 132. It is to be understood that, as used herein, the character can refer to a mouse movement, keystroke, mouse click, touchscreen input, etc.

Alternatively, if the verification is unsuccessful, the verification server 160 can determine that the input 132 of the user 106 is unauthorized. In some examples, the verification may be unsuccessful due to the input 132 being unauthorized input 164 associated with a malicious actor. The malicious actor may generate the unauthorized input 164 via remote access of the user device 120, for example after intercepting a remote commection 152 to the client server 170 that has been authenticated by the user 106. In some examples, through the verification process, the verification server 160 may determine that the input 132 is not physically inputted via the interface 130, thereby causing the verification server 160 to transmit a warning notification 168 to a different computing system (e.g., the client server 170, an external monitoring system 180, or another suitable server). In some examples, the external monitoring system 180 can be specified by the user 106 and may include software to monitor devices, traffic, applications, or a combination thereof. Additionally or altematively, the malicious actor may install a virus or another type of malware on the user device 120 or the user computing system 110 to generate unauthorized input 164, for example by intercepting and modifying the input 132 of the user 106.

If either the input signal 134 or the integrity key 114 is unverified (i.e., indicating that the input 132 is unauthorized), the verification server 160 may communicate with the client server 170 to cause at least one security measure 174 based on a security policy 176 (e.g., the security profile stored in the user record database 162) associated with the user 106. Additionally or alternatively, if the verification server 160 transmits the warning notification 168 to the external monitoring system 180, the external monitoring system 180 can determine the security measure 174 to address the waring notification 168. Once the external monitoring system 180 determines the security measure 174, the external monitoring system 180 can transmit a response message to the verification server 160 or another suitable server (e.g., the client server 170) to implement the security measure 174.

In response to an unsuccessful verification of the input signal 134, the client server 170 may request additional authorization from the user 106, such as using a separate multi-factor authentication system (e.g., Duo, YubiKey, Google Authenticator, etc.). In some examples, the verification server 160 may request additional authorization from the user 106 in response to determining that the input 132 lacks corresponding physical input from the user 106. For example, the input 132 may be existing text copied by the user 106 and pasted as the input 132 to interact with the client server 170. Once the verification server 160 detects this copy-paste input, the verification server 160 may transmit a request to the user device 120 to obtain the additional authorization from the user 106 through the separate multi-factor authentication system. If this additional authorization from the user 106 is valid, the client server 170 may allow the input 132 from the user 106. Alternatively, if the additional authorization is invalid, the client server 170 then may implement additional security measures (e.g., notifying security personnel) to address the unauthorized input 164.

The verification server 160, the client server 170, or another suitable computing system (e.g., the external monitoring system 180) can determine a suitable security measure 174 by applying a rule set. For example, the verification server 160 may select the rule set from one or more rule sets stored in a rule database that may be local to or remote from the verification server 160. By selecting a suitable rule set, the verification server 160 or the client server 170 can determine the suitable security measure 174 to prevent an attacker from migrating or escalating from a compromised user device to another user device communicatively coupled to the client server 170. In some examples, a machine-learning model can be trained to identify or generate the rule set used to determine the security measure 174, for example based on the security policy 176, the unauthorized input 164, or a combination thereof. During training, training data associated with selecting or generating a suitable rule set can be supplied to the machine-learning model, enabling the machine-learning model to identify patterns related to the training data or to identify relationships between the training data and output data (e.g., a rule set selected to address the unauthorized input 164).

Additionally or alternatively, the security policy 176 may be at least in part set by an administrator associated with the client server 170. In some examples, the security measure 174 may include but are not limited to the verification server 160 ignoring the input signal 134 and instructing the client server 170 not to accept it; to verification server 160 requesting out-of-band (such as through multi-factor authentication or content affirmation via a separate channel) authentication of unverified input; the verification server 160 requesting a client 110-server 160 connection to be terminated; the verification server 160 sending a warning notification 168 to alert the administrator, security systems (SOC or SIEM), or other entities that the unverified input has been attempted; among others; or a combination thereof.

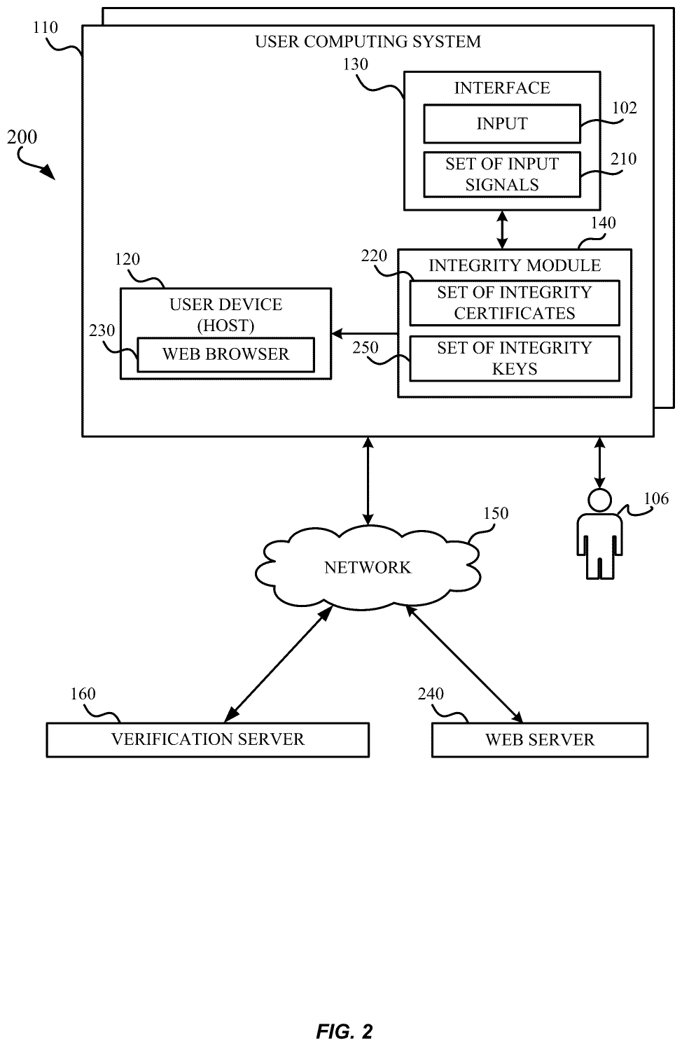

In some examples, instead of verifying each input signal 134 singly, the verification server 160 may verify a set of integrity certificates 220 received from a web server 240 that is communicatively coupled to the user computing system 110. The set of Integrity certificates 220 can include at least one integrity certificate 108 generated by the integrity module 140. FIG. 2 illustrates an example of a system environment 200 for validating a set of input signals 210 of the input 132 from the web server 240 using a set of generated integrity keys 250 according to embodiments. As shown in FIG. 2, the system environment 200 can include the web server 240 communicatively coupled to the user computing system 110 via the network 150. Specifically, the user computing system 110 can communicate with the web server 240 via a web browser 230 accessible using a user device 120 in the user computing system 110.

Additionally, instead of transmitting each input signal 134 singly, the interface 130 can transmit the set of input signals 210 and the set of integrity certificates 220 to the verification server 160 at a time. For example, the web server 240 may transmit the set of integrity certificates 220 to the verification server 160 via a verification request (e.g., using an application programming interface (API) call). In some examples, the web server 240 can group each set of integrity certificates 220 based on one or more fields available in the web browser 230. Examples of the fields can include an email subject line, a transaction amount field, an address field, etc. For example, the web browser 230 or the web server 240 can detect an ending signal corresponding to the user 106 switching from a first field to a second field in the web browser 230. Based on this ending signal, the web server 240 can transmit a first set of integrity certificates corresponding to the first field separately from a second set of integrity certificates corresponding to the second field. Additionally, the sequential identifier 144 for each integrity certificate 108 transmitted by the web server 240 can indicate an order by which the set of input signals 210 was inputted by the user 106, enabling the web server 240 or the verification server 160 to identify non-consecutive input (e.g., editing) from the user 106. If one or more integrity certificates 108 of the set of integrity certificates 220 from the web server 240 is deemed invalid or unverified by the verification server 160, the verification server 160 can determine a suitable security measure as described above with respect to FIG. 1. For example, the verification server 160 may deny or block the set of input signals in response to determining that an integrity certificate 108 of the set of integrity certificates 220 is invalid.

Returning to FIG. 1, in some embodiments, the user computing system system(s) 110, the verification server 160 and/or the client server(s) 170, may include any computing or data processing device consistent with the disclosed embodiments. The user computing system 110 and the verification server 160 and/or the client server 170 may transmit and receive data across a communications network (e.g., the network 150).

By way of example, the network 150 can include one or more communication networks such as a data network, a wireless network, a telephony network, or any combination thereof. The data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, NFC/RFID, RF memory tags, touch-distance radios, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof. The user computing system 110, the verification server 160 and/or the client server 170 may further implement aspects of the disclosed embodiments without accessing other devices or networks, such as the network 150.

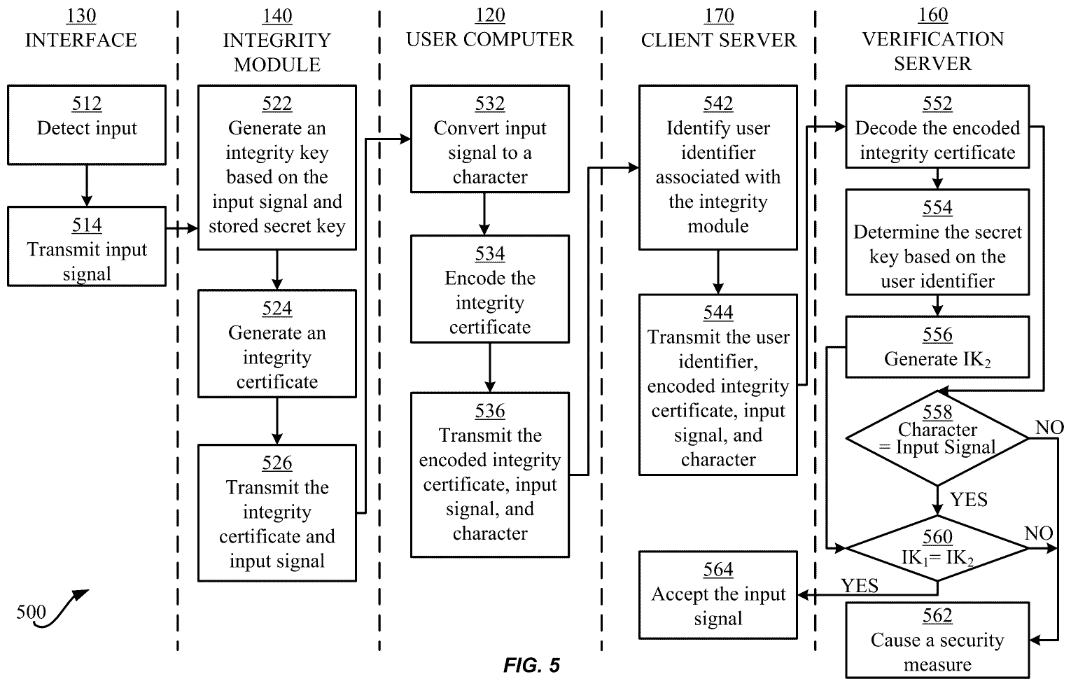

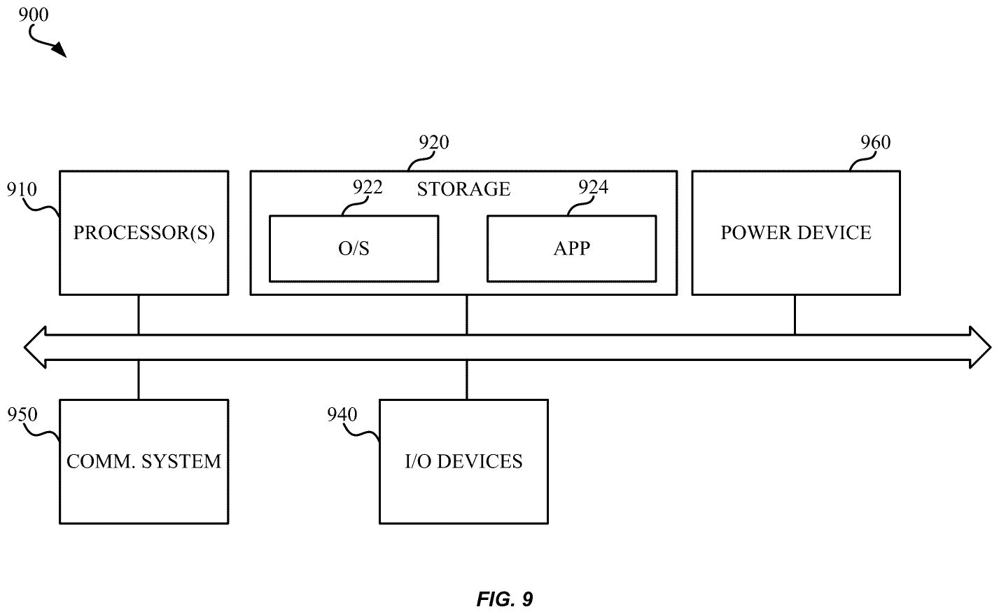

The user computing system 110, the verification server 160 and/or the client server 170 may include one or more computing systems for processing, storing, receiving, obtaining, and/or transmitting information, such as computing system 900 described in connection with FIG. 9. In some aspects, the user computing system 110, the verification server 160 and/or the client server 170 may be implemented with hardware components and/or software instructions to perform one or more operations consistent with the disclosed embodiments (e.g., the example embodiments described with reference to FIGS. 5-7). The software instructions may be incorporated into a single computer or any additional or alternative computing device/system (e.g., a single server, multiple devices/servers, etc.). The user computing system 110 may also include or associate with distributed computing devices and computing systems and may execute software instructions on separate computing systems by remotely communicating over a network (e.g., the network 150). The user computing system 110, the verification server 160 and/or the client server 170 may also implement aspects of the disclosed embodiments without accessing other devices or networks, such as the network 150. The user computing system 110, the verification server 160 and/or the client server 170 may also be implemented with one or more data storages for storing information consistent with the embodiments described below.

Although the systems/devices of the system environment 100 are shown as being directly connected, the user computing system 110 may be indirectly connected to one or more of the other systems/devices of the system environment 100. In some embodiments, the user computing system 110 may be only directly connected to one or more of the other systems/devices of the system environment 100.

It is also to be understood that the system environment 100 may omit any of the devices illustrated and/or may include additional systems and/or devices not shown. It is also to be understood that more than one device and/or system may be part of the system environment 100 although one of each device and/or system is illustrated in the system environment 100. It is further to be understood that each of the plurality of devices and/or systems may be different or may be the same. For example, one or more of the devices of the devices may be hosted at any of the other devices. By way of example, the client server 170 may be hosted at the verification server 160. As another example, the system environment 100 may include more than one verification server 160, such as when the user 106 connects to the client server 170 through another client server. In such examples, a verification server 160 can correspond to the client server 170, while another verification server can correspond to the other client server.

FIG. 3 shows an example of a hardware implementation of an integrity module 300 (e.g., the integrity module 140 of FIG. 1) according to embodiments. As shown in FIG. 3, the integrity module 300 may be configured to be wired or wirelessly connected to the user device 120. For example, the integrity module 300 may include a communication interface 310 which may be a port configured for USB, COM, Serial, Parallel, Firewire, or Thunderbolt connection.

In some examples, the integrity module 300 may include one or more processing units 320 and storage 330. The processing unit 320 may be configured to execute instructions for performing various operations, and can include, for example, a micro-controller, a general-purpose processor, or a microprocessor suitable for implementation within a portable electronic device, such as a Raspberry Pi. The processing unit 320 may be communicatively coupled with a plurality of components within the integrity module 300. For example, the processing units 320 may communicate with other components across a bus. The bus may be any subsystem adapted to transfer data within the integrity module 300. The bus may include a plurality of computer buses and additional circuitry to transfer data.

In some embodiments, the processing unit 320 may be coupled to the storage 330. In some embodiments, the storage 330 may offer both short-term and long-term storage and may be divided into several units. The storage 330 may be volatile, such as static random access memory (SRAM) and/or dynamic random access memory (DRAM), and/or non-volatile, such as read-only memory (ROM), flash memory, and the like. Furthermore, the storage 330 may include removable storage devices, such as secure digital (SD) cards. The storage 330 may provide storage of computer readable instructions, data structures, program modules, audio recordings, image files, video recordings, and other data for the integrity module 300. In some embodiments, the storage 330 may be distributed into different hardware modules. A set of instructions and/or code might be stored on the storage 330. The instructions might take the form of executable code that may be executable by the integrity module 300, and/or might take the form of source and/or installable code, which, upon compilation and/or installation on the integrity module 300 (e.g., using any of a variety of generally available compilers, installation programs, compression/decompression utilities, and the like), may take the form of executable code.

In some embodiments, the storage 330 may store a plurality of application modules 336, which may include any number of applications, such as applications for controlling the communication interface 310, the secret key 332, and the sequential identifier 334 (e.g., a counter, timestamp, random number, any suitable function derived from an underlying counter, etc.). The secret key 332 and the sequential identifier 334 can be the secret key 142 and the sequential identifier 144 of FIG. 1. The application modules 336 may include particular instructions related to generations of the integrity key and an integrity certificate (e.g., the integrity certificate 108 of FIG. 1) to be executed by the processing units 320. In some embodiments, certain applications or parts of the application modules 336 may be executable by other hardware modules, such as a communication interface 310. In certain embodiments, the storage 330 may additionally include secure memory, which may include additional security controls to prevent copying or other unauthorized access to secure information.

In some embodiments, the storage 330 may include an operating system 338 loaded therein, such as an Android operating system or any other operating system suitable for mobile devices or portable devices. The operating system 338 may be operable to initiate the execution of the instructions provided by the application modules 336 and/or manage other hardware modules as well as interfaces with a communication interface 310, which may include one or more wireless or wired transceivers. The operating system 338 may be adapted to perform other operations across the components of integrity module 300 including threading, resource management, data storage control, and other similar functionality.

FIG. 4 shows an example of a software implementation of an integrity module 400 (e.g., the integrity module 140 of FIG. 1) according to embodiments. As shown in FIG. 4, the integrity module 400 may be configured to be an application stored on the user device 120 of FIG. 1. Additionally or alternatively, the integrity module 400 may be configured to be a low-level device driver or a hypervisor driver.

In some examples, the integrity module 400 may include one or more processing umits 420 and storage 430. The processing unit 420 may be configured to execute instructions for performing various operations, and can include, for example, a micro-controller, a general-purpose processor, or a microprocessor suitable for implementation within a portable electronic device, such as a Raspberry Pi. The processing unit 420 may be communicatively coupled with a plurality of components within the integrity module 400. For example, the processing units 420 may communicate with other components across a bus. The bus may be any subsystem adapted to transfer data within the integrity module 400. The bus may include a plurality of computer buses and additional circuitry to transfer data.

In some embodiments, the processing unit 420 may be coupled to the storage 430. In some embodiments, the storage 430 may offer both short-term and long-term storage and may be divided into several units. The storage 430 may be volatile, such as static random access memory (SRAM) and/or dynamic random access memory (DRAM), and/or non-volatile, such as read-only memory (ROM), flash memory, and the like. Furthermore, the storage 430 may include removable storage devices, such as secure digital (SD) cards. The storage 430 may provide storage of computer readable instructions, data structures, program modules, audio recordings, image files, video recordings, and other data for the integrity module 400. In some embodiments, the storage 430 may be distributed into different hardware modules. A set of instructions and/or code might be stored on the storage 430. The instructions might take the form of executable code that may be executable by the integrity module 400, and/or might take the form of source and/or installable code, which, upon compilation and/or installation on the integrity module 400 (e.g., using any of a variety of generally available compilers, installation programs, compression/decompression utilities, and the like), may take the form of executable code.

In some embodiments, the storage 430 may include a secured container to store the secret key 432. For example, the secured container can be a microcontroller (e.g., a secure cryptoprocessor, a system-on-chip (SoC) secure enclave, etc.) to secure hardware through integrated cryptographic keys. In this example, the secured container may be a trusted platform module (TPM) 431a that can include a hardware random number generator, a cryptographic key generator, remote attestation, decryption capabilities, or a combination thereof. In some examples, the secured container includes the secret key 432 that has been generated during production of the user device. In such examples, an entity that generates the hardware of the user device may ship the user device with the secret key 432 present in the secured container of the storage 430. Additionally or alternatively, the user device may include a key identifier (e.g., hardware serial numbers, BIOS information, etc.) that is usable to derive the secret key.

In some embodiments, the storage 430 may store a plurality of application modules 436, which may include any number of applications, such as applications for controlling the communication interface 410, the TPM 431, and the sequential identifier 434. The application modules 436 may include particular instructions related to generations of the integrity key and an integrity certificate (e.g., the integrity certificate 108 of FIG. 1) to be executed by the processing units 420. In some examples, the application modules 436 may have TPM HMAC functionality/firmware to generate the integrity certificate. In some embodiments, certain applications or parts of the application modules 436 may be executable by other hardware modules, such as a communication interface 410. In certain embodiments, the storage 430 may additionally include secure memory, which may include additional security controls to prevent copying or other unauthorized access to secure information.

In some embodiments, the storage 430 may include an operating system 438 loaded therein, such as an Android operating system, Apple® iOS, or any other operating system suitable for mobile devices or portable devices. The operating system 438 may be operable to initiale the execution of the instructions provided by the application modules 436 and/or manage other hardware modules as well as interfaces with a communication interface 410, which may include one or more wireless or wired transceivers. The operating system 438 may be adapted to perform other operations across the components of integrity module 400 including threading, resource management, data storage control, and other similar functionality.

FIGS. 5-7 show flow charts illustrating examples of verifying at least a subset of one or more input signals 134 of an input 132 received by the client server 170 and/or the verification server 160 during a communication session with or via the client server 170 using shared integrity key according to embodiments. The steps of FIGS. 5-7 are described below with reference to components discussed above in FIG. 1. It will be understood that these are non-limiting examples and that the operations described in these flow charts may be modified according to modifications to the architecture. By way of example, the verification server 160 may perform one or more operations of the client server 170. For example, one or more of the operations may be omitted, performed in parallel, etc. Additionally, one or more operations described herein may be performed along with other operations.

While an interface (e.g., the interface 130 of FIG. 1) in these examples is described with respect to a keyboard, it will be understood that the operations described herein are not limited to this interface (i.e., keyboard) and may be performed for input (e.g., the input 132 of FIG. 1) or input streams received by additional and/or alternative interface(s). It will be understood that that the interface is not limited to a keyboard and may include alternative and/or additional devices, including but not limited to mouse, joystick, game controller, among others, or any combination thereof. Examples of the input can include keystrokes, mouse clicks or movements, joystick or game controller interaction, or touchscreen interaction.

FIG. 5 shows a flow chart illustrating an example of verifying at least one input signal 134 of an input 132 (e.g., keystroke) received by a verification server 160 during a communication session using a hardware implementation of an integrity module 140, for example, as shown and described in FIGS. 1 and 3, according to embodiments. Operations described in flow chart 500 may be performed by a computing environment, such as the system environment 100 described above with respect to FIG. 1 or a computing system 900 described below with respect to FIG. 9.

Although the flow chart 500 may describe the operations as a sequential process, in various embodiments, some of the operations may be performed in parallel or concurrently. In addition, the order of the operations may be rearranged. An operation may have additional steps not shown in the figure. In some embodiments, some operations may be optional. Embodiments of the method/architecture may be implemented by hardware, software, firmware, middleware, microcode, hardware description languages, or any combination thereof. When implemented in software, firmware, middleware, or microcode, the program code or code segments to perform the associated tasks may be stored in a non-transitory computer-readable medium such as a storage medium.

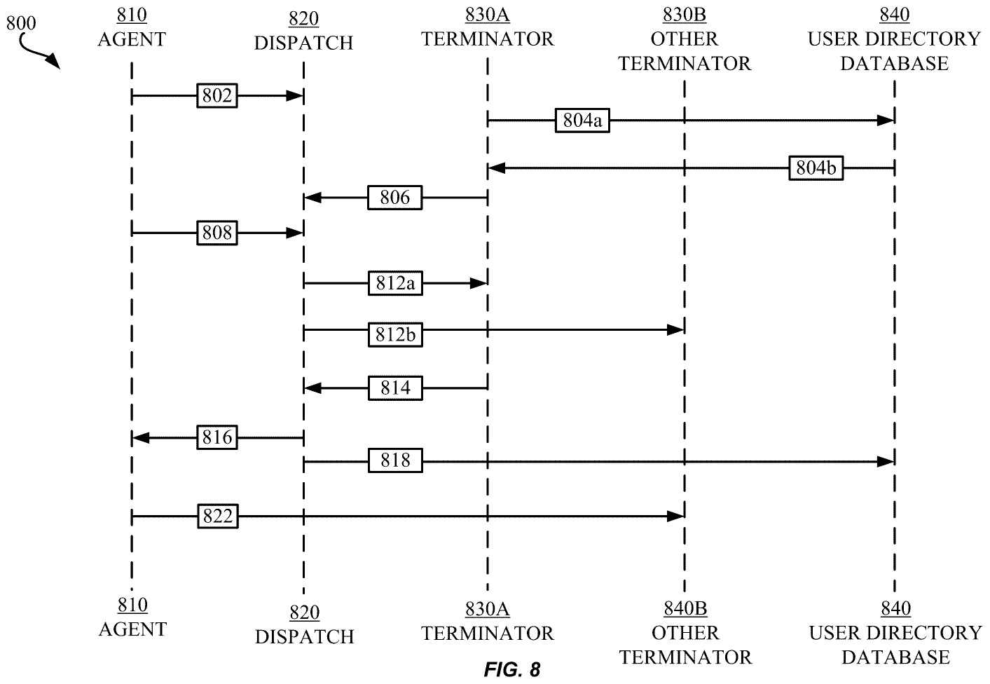

Operations in flow chart 500 may begin at block 512. Before initiating the communication session, the user 106 may first have the integrity module 140 connected to the interface 130 (e.g., keyboard). Additionally, if the user computing system 110 is executing the integrity module 140 for a first time, the user computing system 110 can initiate a pairing process with the client server 170. The pairing process is described further below with respect to FIG. 8.

At block 512, the interface 130 may detect an input 133 in response to a key that was physically touched, or otherwise interacted with, by a user 106. For example, if the interface 130 is a keyboard, the user 106 pressing a key on the keyboard can cause the interface 130 to detect an input 133 of a character corresponding to the key on the keyboard. As another example, if the interface 130 is a computer mouse, the interface 130 can detect an input 132 from the user 106 pressing the wheel or a button of the computer mouse, such as a right click or a left click.

At block 514, the interface 130 may transmit an input signal 134 corresponding to the input 132 to the integrity module 140. In response to detecting the input 132 caused by the user 106, the interface 130 may convert the input 132 into an input signal 134 (e.g., hexadecimal representation of a character typed by the user 106 using the keyboard). In some embodiments, such conversations may group key codes together, map key codes to characters of a different keymaps, and/or perform other functional transfornations on the input 132 to produce input signal 134.

At block 522, the integrity module 140 may receive the input signal 134 and generate an integrity key 114a based on the received input signal 134 and the secret key 142a stored in the integrity module 140. In some examples, at block 522, the integrity module 140 may increment the sequential identifier 144 (e.g., a counter, timestamp, random number, any suitable function derived from an underlying counter, etc.) in the memory by 1. The integrity module 140 may generate the integrity key (IK) by applying a cryptographic protocol 115 (e.g., SHA-256 and/or SHA3-256 (Keccak) secure hash algorithms (SHA)) to the input signal 134, sequential identifier 144, and secret key 142a. Some other embodiments of the integrity module 140 may use different mathematical transformations to generate the IK, including digital signature schemes based on asymmetric cryptography (such as RSA's PKCS #1, Elliptic-Curve public-key algorithms like ECDSA, ECDH, or others), hash functions consistent with post-quantum cryptography (such as Kyber), or others. Yet other embodiments of integrity module 140 may combine one or more cryptographie protocols 115 (e.g., hash functions, digital signature schemes, etc.), the input signal 134, the secret key 142a, and optionally the sequential identifier 144, to the integrity key 114a.

At block 524, the integrity module 140 may generate an integrity certificate 108. In some examples, the integrity certificate 108 may correspond to a tuple 112 (e.g., <input signal, sequential identifier, IK> or <sequential identifier, IK>) that contains an immutable ordered sequence of elements. For example, the integrity module 140 may generate a sequence of characters as the tuple 112 corresponding to the integrity certificate 108. After, at block 526, the integrity module 140 may transmit the integrity certificate 108 and the input signal 134 in one or more messages to the user device 120.

At block 532, the user device 120 may receive the integrity certificate 108 and the input signal 134. At block 532, the user device 120 may receive a full value of the input signal 134 and a current value of the sequential identifier 144 but does not receive a copy of the first secret key 142a. The user device 120 instead receives the integrity key 114b that was generated using the second secret key 142b.

At block 532, the user device 120, for example, using the O/S, may convert the input signal 134 included in the integrity certificate 108 to the corresponding (original) character. At block 534, the user device 120, for example, using the integrity application 122, may encode the integrity certificate 108 (block 526). At block 536, the user device 120 may then transmit the encoded integrity certificate 108 and the character to the client server 170 via the network 150.

Next, at block 542, the client server 170 may identify a user identifier 116 associated with the integrity module 140 for which it received a message (character and the encoded integrity certificate via the user device 120), for example, using any known authentication techniques.

At block 544, the client server 170 may connect to the verification server 160 and then transmit a message including the user identifier 116, the encoded integrity certificate 108, the input signal 134 and the character. In some embodiments, the character or other representations of the input signal may be omitted.

At block 552, the verification server 160 may decode the received (encoded) integrity certificate 108 to determine the input signal 134, the sequential identifier 144, and the integrity key 114a (which can be referred to as “IK₁”). In some examples, the verification server 160 may proceed with the operations at blocks 552-564 if the input 132 is of a type to be processed according to a security profile of the system environment 100. At block 554, the verification server 160 may determine another secret key 142b registered to the user 106 by looking up the other secret key 142b in the user record database 162 using a user identifier 116. Next, at block 556, the verification server 160 may generate a (second) integrity key (IK₂) 114b using the received input signal 134, the received sequential identifier 144, and the retrieved secret key 142b to verify the received integrity key (IK₁) 114a.

At block 558, the verification server 160 may compare the input signal 134 (block 514) to the character (block 544) to determine whether they match. If the input signal 134 transmitted by the interface 130 does not match the character transmitted in the message (NO at block 558), the verification server 160 may consider the input 132 to be invalid or unauthorized and can cause a security measure 174 based on a security policy 176 (block 562). If the input signal 134 transmitted by the interface 130 matches the character transmitted in the message (YES at block 556), the verification server 160 may compare the integrity key (IK₁) 114a (block 524) received in the message and the other integrity key (IK₂) 114b (block 556) generated using the input signal 134 and sequential identifier 144 received in the message to determine whether they match at block 560. If the verification server 160 determines that the integrity keys 114a-b match (YES at block 560), the input 132 (block 512) can be considered valid. The verification server 160 can communicate to the client server 170 to accept the input 132 (block 412) at block 564. If the verification server 160 determines that the integrity keys 114a-b do not match (NO at block 560), the input 132 (block 512) can be considered invalid or unauthorized. The verification server 160 can cause the security measure 174 based on the security policy 176 for the entity configured by the administrator and/or for the user 106 at block 562.

It will be understood that steps 512-564 may be repeated for further input signals of additional input received by the verification server 160 and/or the client server 170 during the communication session. This way, the integrity of the entire communication session can be maintained, limiting access of the client server 170 to correspond to verified input from the user 106. Additionally, it will be understood that steps 512-564 can be implemented to process a set of input signals that can include more than one input signal. As an illustrative example, if the set of input signals includes ‘a’, ‘b’, and ‘c’ the verification server 160 may verify attestation for a collective sequence of the set of input signals as ‘abc’. Specifically, instead of performing steps 512-564 three times, once per input signal, the verification server 160 may perform steps 512-564 once for the set of three input signals.

FIG. 6 shows a flow chart illustrating an example of verifying an input 132 (e.g., keystroke) received by the client server 170 and/or the verification server 160 during a communication session using a software implementation of an integrity module 140, for example, as shown and described in FIGS. 1 and 4, according to embodiments. Operations described in flow chart 600 may be performed by a computing environment, such as the system environment 100 described above with respect to FIG. 1 or a computing system described below with respect to FIG. 9. Although the flow chart 600 may describe the operations as a sequential process, in various embodiments, some of the operations may be performed in parallel or concurrently. In addition, the order of the operations may be rearranged. An operation may have additional steps not shown in the figure. In some embodiments, some operations may be optional. Embodiments of the method/architecture may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium.

Operations in flow chart 600 may begin at block 612, the interface 130 (e.g., keyboard) may detect an input 132 in response to a key or switch of the interface 130 that was physically touched, or otherwise inputted, by a user 106. In examples in which the interface 130 is a touchscreen, the user 106 may generate the input 132 interacting with the touchscreen (e.g., a multi-finger screen touch). At block 614, the interface 130 may transmit an input signal 134 (e.g., hexadecimal representation of a physical character typed by the user 106 on the keyboard) corresponding to the input 132 to the user device 120.

Next, at block 622, the integrity module 140 of the user device 120 may receive the input signal 134 and generate an integrity key 114a based on the received input signal 134 and the stored secret key 142a. In some examples, at block 622, the integrity module 140 may use a trusted platform module (TPM) 431 to look up the secret key 142a stored in the persistent memory in the TPM 431 and to generate the integrity key 114a. For example, the integrity module 140 may cause the TPM 431 to increment the sequential identifier 144 in the persistent TPM memory by 1. The integrity module 140, using the TPM 431, may generate the integrity key (IK) 114a by applying a cryptographie protocol 115 (e.g., SHA-256 and/or SHA3-256 (Keccak) secure hash algorithms (SHA)) to the input signal 134, the sequential identifier 144, and the secret key 142a. In an alternative example, the integrity module 140 instead may access the 142a that is stored in a privileged location of the storage 430 that a malicious actor is unable to access without administrative privileges.

At block 624, using the TPM 431, the integrity module 140 may generate an integrity certificate 108. In some examples, the integrity certificate 108 may correspond to a tuple 112 of <input signal, sequential identifier, IK> or <sequential identifier, IK>. After, at block 626, the integrity module 140 may transmit the integrity certificate 108 in one or more messages to the integrity application 122.

At block 632, the user device 120 may convert the input signal 134 received from the interface 130 to the corresponding (original) character. At block 634, the user device 120, (e.g., application/O/S) of the user device 120 may receive the integrity certificate 118 from the integrity module 140. At this step, the user device 120 may receive a full value of the input signal 134 and a current value of the sequential identifier 144 but does not receive a copy of the secret key 142a. The user device 120 rather receives the other integrity key 114b that was generated using the secret key 142b. At block 634, the user device 120, for example, using the integrity application 122, may encode the integrity certificate 108. At block 636, the user device 120 may then transmit the character and the encoded integrity certificate 108 (representing the 3-tuple) to the client server 170 via the network 150.

In some examples, the verification operations at blocks 642-664 performed by the verification server 160 and/or the client server 170 may be similar to those described with respect to FIG. 5. At block 642, the client server 170 may identify a user identifier 116 associated with the integrity module 140 for which the client server 170 received a message (character and the encoded integrity certificate via the user device 120), for example, using any known authentication techniques.

At block 644, the client server 170 may connect to the verification server 160 and then transmit a message including the user identifier 116, the encoded integrity certificate 108, the input signal 134, and the character.

At block 652, the verification server 160 may decode the received (encoded) integrity certificate 108 to determine the input signal 134, the sequential identifier 144, and the integrity key (IK₁) 114a. In some examples, the verification server 160 may proceed with the operations at blocks 652-664 if the input 132 is of a type to be processed according to a security profile of the system environment 100. At block 654, the verification server 160 may determine another secret key 142b registered to the user 106 by looking up the other secret key 142b in the user record database 162 using the user identifier 116. Next, at block 656, the verification server 160 may generate a (second) integrity key (IK₂) 114b using the received input signal 134, the received sequential identifier 144, and the retrieved secret key 142b.

At block 658, the verification server 160 may compare the input signal 134 (block 614) to the character (block 644) to determine whether they match. If the input signal 134 transmitted by the interface 130 does not match the input signal 134 transmitted in the message (NO at block 658), the verification server 160 may consider the input 132 to be invalid and cause a security measure 174 based on a security policy 176 (block 662). If the input signal 134 transmitted by the interface 130 matches the input signal 134 transmitted in the message (YES at block 656), the verification server 160 may compare the first integrity key (IK₁) 114a (block 624) received in the message and the second integrity key (IK₂) 114b (block 656) generated using the input signal 134 and the sequential identifier 144 received in the message at block 660. If the verification server 160 determines that the integrity keys 114a-b match (YES at block 660), the input 132 (block 612) can be considered valid or authorized. The verification server 160 then can communicate to the client server 170 to accept the input 132 (block 612) at block 664.

Ifthe verification server 160 determines that the integrity keys 114a-b do not match (NO at block 660), the input 132 (block 612) can be considered invalid. The verification server 160 can transmit a warning notification 168 to the client server 170, causing a security measure 174 based on the security policy 176 for the entity configured by the administrator and/or for the user 106 at block 662. In some examples, the security measure 174 may involve allowing a predetermined number of uncertified characters to account for false positive results associated with incorrectly indicating when malicious activity is occurring. Additionally or alternatively, the client server 170 may ignore uncertified input, thus preventing lateral escalation attempts by a malicious actor. Further examples of the security measure 174 can include logging the user 106 off from the remote connection 152, disabling access of the user 106 to the protected computing resources, automatically executing countermeasures or investigations to identify the malicious actor, or a combination thereof.

It will be understood that steps 612-664 may be repeated for further input signals of additional input received by the verification server 160 and/or the client server 170. This way, the integrity of the entire communication session can be maintained.

FIG. 7 shows a flow chart illustrating an example of verifying an input 132 (e.g., keystroke, or a set of keystrokes) to a web browser 230. The input 132 into the operating system (at block 732) and into the web browser 230 (at block 736) may be received using a hardware implementation of the integrity module 140, for example, as shown and described in FIGS. 1 and 2, according to embodiments. In some embodiments, the web browser 230 may buffer a set of input signals 210 and a set of corresponding integrity certificates 220 before submitting the buffer contents to the verification server 160 via the client server 170.

Operations described in flow chart 700 may be performed by a computing environment, such as the system environments 100 and 200 described above with respect to FIG. 1 and FIG. 2 or a computing system described below with respect to FIG. 9. Although the flow chart 700 may describe the operations as a sequential process, in various embodiments, some of the operations may be performed in parallel or concurrently. In addition, the order of the operations may be rearranged. An operation may have additional steps not shown in the figure. In some embodiments, some operations may be optional. Embodiments of the method/architecture may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium.

Operations in flow chart 700 may begin at block 712. Before initiating the communication session, the user 106 may first have the integrity module 140 connected to the interface 130 (e.g., keyboard) and initiate a communication session to a web server 240 (e.g., a third-party server) using a web browser 230 on the user device 120. Once the web browser 230 on the user device 120 connects to the web server 240, the client server 170 can terminate a connection (e.g., SSL connection) between the web browser 230 and the web server 240 and create another connection between a proxy server and the web server 240. The proxy server can be an intermediary server that communicatively couples the user device 120 to the web server 240.

After a connection between the proxy server and the web server 240 is created, at block 612, the interface 130 may detect an input 132 in response to a key that was physically touched, or otherwise inputted, by a user 106. At block 714, the interface 130 may transmit an input signal 134 (e.g., hexadecimal representation of the physical character typed by the user 106 on the keyboard, a mouse click, or a touchscreen tap) corresponding to the input 132.

Next, at block 722, the integrity module 140 may receive the input signal 134 and generate an integrity key 114a based on the received input signal 134 and the stored secret key 142a. In some examples, at block 722, the integrity module 140 may increment the sequential identifier 144 in the memory by 1. The integrity module 140 may generate the integrity key (IK) by applying a cryptographic protocol 115 (e.g., SHA-256 and/or SHA3-256 (Keccak) secure hash algorithms (SHA)) to the input signal 134, sequential identifier 144, and secret key 142a. At block 724, the integrity module 140 may generate an integrity certificate 108. In some examples, the integrity certificate 108 may correspond to a tuple 112 of <input signal, sequential identifier, IK> or <sequential identifier, IK>. After, at block 726, the integrity module 140 may transmit the integrity certificate 108 and the input signal 134 in one or more messages to the user device 120.

At block 732, the user device 120 may receive the integrity certificate 108 and the input signal 134. At block 732, the user device 120 may receive a full value of the input signal 134 and a current value of the sequential identifier 144 but does not receive a copy of the secret key 142a. The user device 120 rather receives the integrity key 114b that was generated using the stored secret key 114bb, thus limiting access to the secret keys 142a-b to increase data security.

At block 732, an operating system (O/S) may convert the input signal 134 included in the integrity certificate 108 to the corresponding (original) character. At block 734, the user device 120, for example, using an integrity application 122 (e.g., driver), may encode the integrity certificate 108. In some examples, the integrity application 122 may transmit the encoded integrity certificate 108 to the O/S. In some examples, at block 734, the O/S may then transmit the encoded integrity certificate 108 and the character to the web browser 230.

At block 736, the web browser 230 may receive the encoded integrity certificate 108 (representing the 3-tuple) via the O/S. In some examples, the web browser 230 may also receive from the O/S the character (e.g., a letter) corresponding to the input signal 134 received from the interface 130 (block 714). For example, an input signal 134 for number ‘8’ may be translated into a composite character because a combination of a Shift modifier key and a key for the number ‘8’ was pressed. Specifically, the interface 130 may transmit a separate input signal 134 for the number ‘8’, the Shift modifier key, and the composite character ‘*’.

At block 736, a browser extension within the web browser 230 may track text or number fields (e.g., define browser areas in which the user 106 can type characters, such as e-mail subjects or comments) within designated website(s). In some examples, the designation can be policy-specific. For example, the designation can involve all websites (for auditing purposes), a subset of websites where a secret key 142 is required, application programming interfaces (API), among others, or any combination thereof.

At block 736, the browser extension may within the web browser 230 to consume the encoded integrity certificate 108 and associated characters (blocks 712-734) for the designated websites. For example, the buffer may store the integrity certificate 108 and associated characters as 2-tuples (<character, <input signal, sequential identifier, IK>>). This way, the buffer may accumulate a set of encoded integrity certificates 220 and the associated characters.

At block 738, upon the web browser 230 submitting a request to the web server 240, a browser extension can add an additional field to an outgoing HTTP request. For example, each HTTP GET or POST request with a text field with identifier I that was tracked by the browser extension can receive an additional text field with identifier v(I), where v is a function for generating a unique name. The additional text field with identifier v(I) can contain serialized content of the buffer, providing a correspondence between the characters that were typed in the text field and the set of integrity keys 250 corresponding to a respective character.

At block 742, the client server 170 may receive the HTTP, HTTPS or Websocket request including the text fields. At block 744, the client server 170 may identify a user identifier 116 associated with the integrity module 140 for which the client server 170 received a message (character and the encoded integrity certificate 108 via the user device 120), for example, using any known authentication techniques.

Based on a policy associated with user 106 and/or user device 120, the proxy server can select v(I) for each text field that the policy dictates should be verified by the verification server 160. In some examples, the policy may include all text or number field form elements and/or a subset thereof.

At block 746, the client server 170 may connect to the verification server 160 and then transmit a message including the user identifier 116, the encoded integrity certification 108, the input signal 134, and the character.

At block 752, the verification server 160 may decode the received (encoded) integrity certificate 108 from the buffer of the web browser 230 to determine the input signal 134, the sequential identifier 144, and the integrity key 114a.

At block 754, the verification server 160 may determine another secret key 142b registered to the user 106 by looking up the other secret key 142b in the user record database 162 using a user identifier 116. Next, at block 756, the verification server 160 may generate a (second) integrity key (IK₂) 114b using the received input signal 134, the received sequential identifier 144, and the retrieved secret key 142b.

At block 758, the verification server 160 may compare a set of input signals 210 received in the text field (block 714) to a corresponding set of characters (block 744) to determine whether they are valid (e.g., match). Each character received in the text field must correspond to some valid character in the set of input signals 210 and the corresponding set of integrity certificates 220. Specifically, if the set of input signals 210 received in the text field does not match an equally sized subset of character(s) transmitted in the message (NO at block 758), the verification server 160 may consider the input 132 to be invalid and cause a security measure 174 based on a security policy 176 (block 762). Otherwise, if the set of input signals 210 received in the text field matches the equally sized subset of character(s) transmitted in the message (YES at block 756), the verification server 160 may compare the set of integrity certificates 220 (block 724) received in the message and the set of integrity certificates 220 (block 756) generated using the set of input signals 210 and sequential identifiers received in the message at block 760. If the verification server 160 determines that the set of integrity certificates 220 match (YES at block 760), the input 132 (block 512) can be considered valid. The verification server 160 then can communicate to the client server 170 to accept the set of input signals 210 (block 712) at block 764. At block 764, the verification server 160 can optionally remove the v(I) integrity key buffers from the request body and the request to the web server 240 transparently (e.g., as it would do without the verification process disclosed therein).

If the verification server 160 determines that the set of integrity certificates 220 do not match (NO at block 760), the input 132 (block 712) can be considered invalid. The verification server 160 can cause a security measure 174 based on the security policy 176 for the entity configured by the administrator and/or for the user 106 at block 762. For example, depending on the security policy 176 configured by the administrator, the verification server 160 could ignore the input signal 134 without permitting the third-party server to receive it, thus generating a client error in the browser; the verification server 160 could issue a direct response to the web browser 230 to notify an end-user; the verification server 160 could request out-of-band (such as multi-factor authentication) authentication of the unverified input or unverified set of input; the verification server 160 could request the client-server connection to be terminated; the verification server 160 could communicate to the system administrator that a rogue text entry (e.g., a set of keystrokes) has been attempted, among others, or any combination thereof.

FIG. 8 depicts a data flow diagram 800 of an example of a data flow for pairing an integrity key of an agent 810 to a user identifier of a terminator 830 according to embodiments. Operations described in data flow diagram 800 may be performed by a computing environment, such as the system environments 100 described above with respect to FIG. 1 or a computing system described below with respect to FIG. 9. Although the data flow diagram 800 may describe the operations as a sequential process, in various embodiments, some of the operations may be performed in parallel or concurrently. In addition, the order of the operations may be rearranged. An operation may have additional steps not shown in the figure, In some embodiments, some operations may be optional. Embodiments of the method/architecture may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium.

Operations in data flow diagram 800 may begin at block 802. Prior to performing the verification process described above in FIG. 1 through FIG. 7, an agent 810 associated with a user can initiate a matchmaking process (e.g., a trust on first use process) to pair the agent 810 with a corresponding terminator 830a (e.g., the client server 170 of FIG. 1). In some examples, the agent 810 can be the user device 120 or the user computing system 110 of FIG. 1 that is associated with the user 106 of FIG. 1. A dispatch 820 can be an intermediate router communicatively coupling the agent 810 and one or more terminators 830a-b to facilitate the matchmaking process. Additionally, the dispatch 820 can be associated with a user account of the user and can manage a respective sequential identifier (e.g., the sequential identifier 144 of FIG. 1) for each agent communicatively coupled to the dispatch 820. In some examples, more than one user computing system (e.g., a work phone and a work laptop) may be associated with the user account of the dispatch 820. In such examples, the dispatch 820 can oversee a different sequential identifier associated with each user computing system associated with the user account.

In some examples, prior to this matchmaking process, the agent 810 may have a secret key associated with the user and the user computing system but may lack a username used as a user identifier (e.g., the user identifier 116 of FIG. 1) for the user. Conversely, the one or more terminators 830a-b in a system environment (e.g., the system environment 100 of FIG. 1) may have the username but lack the secret key corresponding to the user of the username. Accordingly, the matchmaking process can enable the agent 810 to pair with the corresponding terminator 830a relatively quickly with limited interaction from the user.

At block 802, the agent 810 can register with the dispatch 820 that the agent 810 lacks a username associated with the user of the agent 810. Similarly, at block 804a, the terminator 830a may transmit a request to a user directory database 840 to determine the secret key (e.g., a public key of an asymmetric key pair) corresponding to the username associated with the terminator 830a. The user directory database 840 can store mappings of usernames to secret keys from successful matchmaking processes. At block 804b, the user directory database 840 can transmit a response to address the request from the terminator 830a indicating that the secret key corresponding to the username is unavailable. For example, if the user is a first-time user of the verification process, a mapping of the secret key corresponding to the username may be unavailable in the user directory database 840 until the matchmaking process is completed. At block 806, in response to receiving the response from the user directory database 840, the terminator 830a can transmit another request to the dispatch 820 to register a lack of a corresponding secret key for the username associated with the terminator 830a.

At block 808, the agent 810 can initiate the matchmaking process by transmitting an input message to the dispatch 820. The input message may include the secret key, an integrity key associated with the agent 810, an integrity certificate generated by the agent 810, an input signal (e.g., the input signal 134 of FIG. 1) detected by an interface (e.g., the interface 130 of FIG. 1) coupled to the agent 810, or a combination thereof. At blocks 812a-b, in response to receiving the input message, the dispatch 820 can transmit the secret key of the agent 810 to each terminator of the terminators 830a-b that are available for pairing For example, as depicted in FIG. 8, the dispatch 820 can transmit the secret key to the terminator 830a and another terminator 830b. After receiving the secret key, the terminators 830a-b can verify whether the secret key of the agent 810 matches with a respective username of each terminator. For example, the secret key may match with the username associated with the terminator 830a but not with another username associated with the other terminator 830b.

At block 814, after verifying that the secret key of the agent 810 matches with the username of the terminator 830a, the terminator 830a can transmit a pairing confirmation message that includes the secret key and the username to the dispatch 820. If the other username associated with the other terminator 830b does not match with the secret key of the agent 810, the other terminator 830b may transmit a pairing rejection message to the dispatch 820 to indicate the mismatch between the secret key and the other username. In some examples, the terminator 830a may match more than one input message from the agent 810 to the username of the terminator 830a prior to transmitting the pairing confirmation message to account for a possibility of a false positive match. In such examples, if a predefined number of input messages from the agent 810 matches with the terminator 830a, the terminator 830a then may transmit the pairing confirmation message to the dispatch 820. For example, the terminator 830a may wait until three successful matches are made between the input messages and the terminator 830a before transmitting the pairing confirmation message to the dispatch 820.

At block 816, once the dispatch 820 receives the pairing confirmation message, the dispatch 820 can forward the pairing confirmation message to the agent 810 to inform the agent 810 of the successful match with the terminator 830a. Based on the pairing confirmation message, the agent 810 can associate the secret key with the username of the terminator 830a. Additionally, at block 818, the dispatch 820 may transmit the secret key of the agent 810 to the user directory database 840 to generate a mapping coupling the secret key and the username associated with the terminator 830a. When the agent 810 transmits another input message to the dispatch 820 after the successful matchmaking process, the terminator 830a can transmit another request to the user directory database 840 to determine the secret key corresponding to the username associated with the terminator 830a. Since the mapping corresponding to the username of the terminator 830a and the secret key of the agent 810 is now available in the user directory database 840, the user directory database now can use the mapping to return the secret key of the agent 810 in response to the other request. Once the terminator 830a receives this secret key from the user directory database 840, the terminator 830 can transmit the secret key to the dispatch 820 to forward to the agent 810. At block 822, once the secret key of the agent 810 is paired with the username, the agent 810 can continue with the verification process described above with respect to FIG. 1 through FIG. 7.

FIG. 9 depicts a block diagram of an example computing system 900 for implementing certain embodiments. For example, in some aspects, the computer system 900 may include computing systems associated with a device (e.g., the user device 120, the verification server 160 and/or the client server 170) performing one or more processes (e.g., FIGS. 5-8) disclosed herein. The block diagram illustrates some electronic components of subsystems of the computing system. The computing system 900 depicted in FIG. 9 is merely an example and is not intended to unduly limit the scope of inventive embodiments recited in the claims. One of ordinary skill in the art would recognize many possible variations, alternatives, and modifications. For example, in some implementations, the computing system 900 may have more or fewer subsystems than those shown in FIG. 9, may combine two of more subsystems, or may have a different configuration or arrangement of subsystems.

In the example shown in FIG. 9, the computing system 900 may include one or more processing units 910 and storage 920. The processing units 910 may be configured to execute instructions for performing various operations, and can include, for example, a micro-controller, a general-purpose processor, or a microprocessor suitable for implementation within a portable electronic device, such as a Raspberry Pi. The processing units 910 may be communicatively coupled with a plurality of components within the computing system 900. For example, the processing units 910 may communicate with other components across a bus. The bus may be any subsystem adapted to transfer data within the computing system 900. The bus may include a plurality of computer buses and additional circuitry to transfer data.

In some embodiments, the processing units 910 may be coupled to the storage 920. In some embodiments, the storage 920 may offer both short-term and long-term storage and may be divided into several units. The storage 920 may be volatile, such as static random access memory (SRAM) and/or dynamic random access memory (DRAM), and/or non-volatile, such as read-only memory (ROM), flash memory, and the like. Furthermore, the storage 920 may include removable storage devices, such as secure digital (SD) cards. The storage 920 may provide storage of computer readable instructions, data structures, program modules, audio recordings, image files, video recordings, and other data for the computing system 900. In some embodiments, the storage 920 may be distributed into different hardware modules. A set of instructions and/or code might be stored on the storage 920. The instructions might take the form of executable code that may be executable by the computing system 900, and/or might take the form of source and/or installable code, which, upon compilation and/or installation on the computing system 900 (e.g., using any of a variety of generally available compilers, installation programs, compression/decompression utilities, and the like), may take the form of executable code.

In some embodiments, the storage 920 may store a plurality of application modules 924, which may include any number of applications, such as applications for controlling input/output (I/O) devices 940, a switch, a camera, a microphone or audio recorder, a speaker, a media player, a display device, etc.). The application modules 924 may include particular instructions to be executed by the processing units 910. In some embodiments, certain applications or parts of the application modules 924 may be executable by other hardware modules, such as a communication subsystem 950. In certain embodiments, the storage 920 may additionally include secure memory, which may include additional security controls to prevent copying or other unauthorized access to secure information.

In some embodiments, the storage 920 may include an operating system (O/S) 922 loaded therein, such as an Android operating system or any other operating system suitable for mobile devices or portable devices. The operating system 922 may be operable to initiate the execution of the instructions provided by the application modules 924 and/or manage other hardware modules as well as interfaces with a communication subsystem 950 which may include one or more wireless or wired transceivers. The operating system 922 may be adapted to perform other operations across the components of the computing system 900 including threading, resource management, data storage control, and other similar functionality.

The communication subsystem 950 may include, for example, an infrared communication device, a wireless communication device and/or chipset (such as a Bluetooth® device, an IEEE 802.11 (Wi-Fi) device, a WiMax device, cellular communication facilities, and the like), NFC, ZigBee, and/or similar communication interfaces. The computing system 900 may include one or more antennas (not shown in FIG. 9) for wireless communication as part of the communication subsystem 950 or as a separate component coupled to any portion of the system.

Depending on desired functionality, the communication subsystem 950 may include separate transceivers to communicate with base transceiver stations and other wireless devices and access points, which may include communicating with different data networks and/or network types, such as wireless wide-area networks (WWANs), WLANs, or wireless personal area networks (WPANs). A WWAN may be, for example, a WiMax (IEEE 802.9) network. A WLAN may be, for example, an IEEE 802.11x network. A WPAN may be, for example, a Bluetooth network, an IEEE 802.16x, or some other types of network. The techniques described herein may also be used for any combination of WWAN, WLAN, and/or WPAN. In some embodiments, the communications subsystem 950 may include wired communication devices, such as Universal Serial Bus (USB) devices, Universal Asynchronous Receiver/Transmitter (UART) devices, Ethernet devices, and the like. The communications. subsystem 950 may permit data to be exchanged with a network, other computing systems, and/or any other devices described herein. The communication subsystem 950 may include a means for transmitting or receiving data, such as identifiers of portable goal tracking devices, position data, a geographic map, a heat map, photos, or videos, using antennas and wireless links. The communication subsystem 950, the processing units 910, and the storage 920 may together comprise at least a part of one or more of a means for performing some functions disclosed herein.

The computing system 900 may include one or more I/O devices 940, such as sensors, a switch, a camera, a microphone or audio recorder, a communication port, or the like. For example, the I/O devices 940 may include one or more touch sensors or button sensors associated with the buttons. The touch sensors or button sensors may include, for example, a mechanical switch or a capacitive sensor that can sense the touching or pressing of a button.

In some embodiments, the I/O devices 940 may include a microphone or audio recorder that may be used to record an audio message. The microphone and audio recorder may include, for example, a condenser or capacitive microphone using silicon diaphragms, a piezoelectric acoustic sensor, or an electret microphone. In some embodiments, the microphone and audio recorder may be a voice-activated device. In some embodiments, the microphone and audio recorder may record an audio clip in a digital format, such as MP3, WAV, WMA, DSS, etc. The recorded audio files may be saved to the storage 920 or may be sent to the one or more network servers through the communication subsystem 950.

In some embodiments, the I/O devices 940 may include a location tracking device, such as a global positioning system (GPS) receiver. In some embodiments, the I/O devices 940 may include a wired communication port, such as a micro-USB, Lightning, or Thunderbolt transceiver.

The I/O devices 940 may also include, for example, a speaker, a media player, a display device, a communication port, or the like. For example, the I/O devices 940 may include a display device, such as an LED or LCD display and the corresponding driver circuit. The I/O devices 940 may include a text, audio, or video player that may display a text message, play an audio clip, or display a video clip.

The computing system 900 may include a power device 960, such as a rechargeable battery for providing electrical power to other circuits on the computing system 900. The rechargeable battery may include, for example, one or more alkaline batteries, lead-acid batteries, lithium-ion batteries, zinc-carbon batteries, and NiCd or NiMH batteries. The computing system 900 may also include a battery charger for charging the rechargeable battery. In some embodiments, the battery charger may include a wireless charging antenna that may support, for example, one of Qi, Power Matters Association (PMA), or Association for Wireless Power (A4WP) standard, and may operate at different frequencies. In some embodiments, the battery charger may include a hard-wired connector, such as, for example, a micro-USB or Lightning® connector, for charging the rechargeable battery using a hard-wired connection. The power device 960 may also include some power management integrated circuits, power regulators, power convertors, and the like.

The computing system 900 may be implemented in many different ways. In some embodiments, the different components of the computing system 900 described above may be integrated to a same printed circuit board. In some embodiments, the different components of the computing system 900 described above may be placed in different physical locations and interconnected by, for example, electrical wires. The computing system 900 may be implemented in various physical forms and may have various external appearances. The components of computing system 900 may be positioned based on the specific physical form.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

While the terms “first” and “second” are used herein to describe data transmission associated with a subscription and data receiving associated with a different subscription, such identifiers are merely for convenience and are not meant to limit various embodiments to a particular order, sequence, type of network or carrier.

Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing (e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more example embodiments, the functions described may be implemented in hardware, software, firmware, or any combination thereof. If implemented in software, the functions may be stored as one or more instructions or code on a non-transitory computer readable medium or non-transitory processor-readable medium. The operations of a method of algorithm disclosed herein may be embodied in a processor-execut ble software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields of particles, optical fields or particles, or any combination thereof.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AC, BC, AA, ABC, AAB, AABBCCC, and the like.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The disclosures of each and every publication cited herein are hereby incorporated herein by reference in their entirety.

While the disclosure has been described in detail with reference to exemplary embodiments, those skilled in the art will appreciate that various modifications and substitutions may be made thereto without departing from the spirit and scope of the disclosure as set forth in the appended claims. For example, elements and/or features of different exemplary embodiments may be combined with each other and/or substituted for each other within the scope of this disclosure and appended claim.

What is claimed is:

1. A computer-implemented method comprising:
receiving an input signal associated with a user using a remote connection to access a client server, the input signal identifying an input received via an interface;
executing an integrity module to generate an integrity certificate using the input signal, a secret key, and a sequential identifier corresponding to the input, the integrity certificate being generated for use during a verification process associated with the input signal; and
transmitting the integrity certificate and the input signal to the client server using one or more channels, the client server being configured to forward the integrity certificate and the input signal to a verification server configured to validate the integrity certificate.

2. The computer-implemented method of claim 1, wherein generating the integrity certificate further comprises:
generating, by the integrity module, a tuple encoding the integrity certificate, wherein the tuple comprises:
the sequential identifier that indicates an order of the input signal; and
an integrity key created based on the input signal, the secret key, and the sequential identifier using a cryptographic protocol.

3. The computer-implemented method of claim 1, wherein the verification process further comprises using the verification server to verify the integrity certificate received from the client server by querying a database using a user identifier associated with the user to identify another secret key stored in the database, wherein the other secret key is associated with the user identifier.

4. The computer-implemented method of claim 3, wherein the verification server is configured to generate another integrity key using the other secret key stored in the database, and wherein the verification server is configured to detect unauthorized input by comparing the integrity key received from the client server with the other integrity key generated by the verification server.

5. The computer-implemented method of claim 3, wherein the other secret key stored in the database is a private key of an asymmetric key pair generated using asymmetric public-key cryptography, and wherein the other secret key is usable to decrypt the secret key that is a public key of the asymmetric key pair.

6. The computer-implemented method of claim 1, wherein the verification server is configured to transmit a warning notification to a different computing system in response to detecting unauthorized input during the verification process.

7. The computer-implemented method of claim 6, wherein, in response to receiving the warning notification from the verification server, the client server is configured to cause a security measure based on a security policy to address the warning notification by denying the input signal with respect to accessing the client server.

8. The computer-implemented method of claim 1, wherein the verification server is further configured to receive a verification request from a web server to verify a set of integrity certificates corresponding to a set of input signals transmitted to the verification server by the web server, and wherein the set of input signals is associated with the user accessing the web server.

9. The computer-implemented method of claim 8, wherein the verification server is configured to deny the set of input signals in response to determining that one or more integrity certificates of the set of integrity certificates are unverified.

10. The computer-implemented method of claim 1, wherein the interface is a keyboard with one or more keyboard keys configured to generate the input signal in response to being selected by the user.

11. The computer-implemented method of claim 1, further comprising:
receiving a set of input signals associated with the user, wherein the set of input signals identifies more than one input received via the interface;
executing the integrity module to generate at least one integrity certificate using the set of input signals, the secret key, and the sequential identifier corresponding to the more than one input; and
transmitting the at least one integrity certificate and the set of input signals to the client server using the one or more channels, wherein the client server is configured to forward the at least one integrity certificate and the set of input signals to the verification server that is configured to validate the at least one integrity certificate.

12. A system comprising:
one or more data processors;
a non-transitory computer readable storage medium containing instructions which when executed on the one or more data processors, cause the one or more data processors to perform actions including:
receiving an input signal associated with a user using a remote connection to access a client server, the input signal identifying an input received via an interface;
executing an integrity module to generate an integrity certificate using the input signal, a secret key, and a sequential identifier corresponding to the input, the integrity certificate being generated for use during a verification process associated with the input signal; and
transmitting the integrity certificate and the input signal to the client server using one or more channels, the client server being configured to forward the integrity certificate and the input signal to a verification server configured to validate the integrity certificate.

13. The system of claim 12, wherein generating the integrity certificate further comprises;
generating, by the integrity module, a tuple encoding the integrity certificat wherein the tuple comprises:
the sequential identifier that indicates an order of the input signal; and
an integrity key created based on the input signal, the secret key, and the sequential identifier using a cryptographic protocol.

14. The system of claim 12, wherein the verification process further comprises using the verification server to verify the integrity certificate received from the client server by querying a database using a user identifier associated with the user to identify another secret key stored in the database, wherein the other secret key is associated with the user identifier.

15. The system of claim 14, wherein the verification server is configured to generate another integrity key using the other secret key stored in the database, and wherein the verification server is configured to detect unauthorized input by comparing the integrity key received from the client server with the other integrity key generated by the verification server. 16, The system of claim 12, wherein the verification server is configured to transmit a warning notification to the client server in response to detecting unauthorized input during the verification process.

17. The system of claim 16, wherein, in response to receiving the warning notification from the verification server, the client server is configured to cause a security measure based on a security policy to address the warning notification by denying the input signal with respect to accessing the client server.

18. The system of claim 12, wherein the verification server is further configured to receive a verification request from a web server to verify a set of integrity certificates corresponding to a set of input signals transmitted to the verification server by the web server, and wherein the set of input signals is associated with the user accessing the web server.

19. A non-transitory computer-readable medium including instructions configured to cause one or more data processors to perform actions comprising:
receiving an input signal associated with a user using a remote connection to access a client server, the input signal identifying an input received via an interface;
executing an integrity module to generate an integrity certificate using the input signal, a secret key, and a sequential identifier corresponding to the input, the integrity certificate being generated for use during a verification process associated with the input signal; and
transmitting the integrity certificate and the input signal to the client server using one or more channels, the client server being configured to forward the integrity certificate and the input signal to a verification server configured to validate the integrity certificate.

20. The non-transitory computer-readable medium of claim 19, wherein generating the integrity certificate further comprises:
generating, by the integrity module, a tuple encoding the integrity certificate, wherein the tuple comprises:
the sequential identifier that indicates an order of the input signal; and
an integrity key created based on the input signal, the secret key, and the sequential identifier using a cryptographic protocol.
